(19) United States
(12) Patent Application Publication
(10) Pub. No.: US 2006/0067682 A1
(43) Pub. Date: Mar. 30, 2006

(54) Removing apparatus, protective film forming apparatus, substrate processing system and removing method

(75) Inventors: Koji Kaneyama, Kamikyo-ku (JP); Kazuhito Shigemori, Kamikyo-ku (JP)

Correspondence Address: OSTROLENK FABER GERB & SOFFEN, 1180 AVENUE OF THE AMERICAS, NEW YORK, NY, 100368403, US

(73) Assignee: Dainippon Screen Mfg., Co., Ltd.

(21) Appl. No.: 11/226,750

(22) Filed: Sep. 14, 2005

(30) Foreign Application Priority Data
Sep. 29, 2004 (JP) JP2004-283810

(51) Int. Cl. G03D 5/00

(52) U.S. Cl. 396/604

(57) ABSTRACT

An application processing unit forms a cover film of a component soluble in an aqueous alkaline solution on the surface of a substrate formed with a resist film. The application processing unit can supply a developer used in a development processing unit as a remover for removing a cover film component adhering to the peripheral edge of the substrate. Thus, it is possible to selectively remove the cover film from the peripheral edge of the substrate without influencing the resist film.

### BACKGROUND OF THE INVENTION

1. Field of the Invention

The present invention relates to a removing apparatus for removing a protective film formed to cover a resist film on the surface of a semiconductor substrate, a glass substrate for a liquid crystal display or a photomask, a substrate for an optical disk or the like (hereinafter simply referred to as “substrate”), a protective film forming apparatus, a substrate processing system and a removing method, and more particularly, it relates to an improvement for efficiently removing a protective film.

2. Description of the Background Art

A technique of forming a thin film by applying a coating fluid to a substrate while rotating the substrate is known in general. Also known is a technique of removing an unnecessary portion of the thin film adhering to the outer peripheral edge of the substrate in formation of the think film.

A technique related to immersion exposure for executing exposure processing while filling up a clearance between a projection optical system and a substrate with a liquid is also known in general.

When exposure processing is executed by immersion, however, it follows that a resist film formed on the surface of the substrate comes into contact with the liquid (water, for example), to result in such a problem that a resist component is eluted in the liquid. As one of techniques for solving this problem, a resist cover film (hereinafter simply referred to as “cover film”) may be formed to cover the resist film, for executing exposure processing while filling up a clearance between this cover film and the projection optical system with the liquid, for example.

When a component of the cover film adheres to the peripheral edge of the substrate, a remover is supplied for removing an unnecessary portion of the cover film, in order to prevent formation of particles.

Depending on the relation between the component of the cover film, a component of the resist film and the remover, however, the substrate may be defectively processed. In other words, it follows that the supplied remover infiltrates into the cover film and partially dissolves the resist film formed under the cover film when reaching the resist film if the remover removes not only the cover film but also the resist film. Consequently, substrate processing (exposure processing or development processing, for example) cannot be properly executed.

The remover for the cover film is generally prepared from an organic solvent. Therefore, an organic waste resulting from removal processing must be processed to disadvantageously increase the number of steps necessary for overall substrate processing. This problem also arises not only when removing the cover film component adhering to the peripheral edge of the substrate but also when removing the cover film component adhering to the back surface of the substrate or a cup part provided for preventing scattering.

### SUMMARY OF THE INVENTION

The present invention is directed to a removing apparatus for removing a protective film formed to cover a resist film on the surface of a substrate.

According to the present invention, this removing apparatus comprises a holding part holding the substrate and a first supply part supplying an aqueous alkaline solution to the peripheral edge of the unexposed substrate as a remover, while the protective film is soluble in the remover and the resist film is insoluble in the remover except a portion subjected to exposure processing.

It is possible to selectively and easily remove the protective film formed on the peripheral edge of the substrate without influencing the resist film formed on the surface of the substrate.

The present invention is also directed to another removing apparatus for removing a protective film component adhering to a back surface portion of a substrate.

According to the present invention, this removing apparatus comprises a holding part holding the substrate and a supply part supplying an aqueous alkaline solution to the back surface portion of the unexposed substrate as a remover, while the protective film is formed to cover a resist film formed on the surface of the substrate and soluble in the remover, and the resist film is insoluble in the remover except a portion subjected to exposure processing.

It is possible to efficiently remove the protective film component adhering to the back surface portion of the substrate with the remover of the aqueous alkaline solution.

The present invention is also directed to still another removing apparatus.

According to the present invention, this removing apparatus comprises a holding part holding a substrate while rotating the same, a cup part enclosing the substrate held by the holding part and a supply part supplying an aqueous alkaline solution to the cup part to which a protective film component adheres as a remover, while a protective film is formed to cover a resist film on the surface of the substrate and soluble in the remover, and the resist film is insoluble in the remover except a portion subjected to exposure processing.

It is possible to efficiently remove the protective film component adhering to the cup part with the remover of the aqueous alkaline solution.

The present invention is further directed to a protective film forming apparatus for forming a protective film by applying a protective film component to a substrate formed with a resist film.

According to the present invention, this protective film forming apparatus comprises a holding part holding the substrate, a protective film component supply part supplying the protective film component to the substrate held by the holding part and a first remover supply part supplying an aqueous alkaline solution to the peripheral edge of the substrate as a remover, while the protective film is formed to cover the resist film formed on the surface of the substrate and soluble in the remover, and the resist film is insoluble in the remover except a portion subjected to exposure processing.

It is possible to selectively and easily remove only the protective film without influencing the resist film.

Accordingly, an object of the present invention is to provide a removing apparatus capable of excellently removing a protective film component of a protective film formed to cover a resist film without influencing the resist film also when the protective film component adheres to the peripheral edge of a substrate, the back surface of the substrate and/or a cup part, a protective film forming apparatus, a substrate processing system and a removing method.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 illustrates an exemplary structure of a substrate processing system according to an embodiment of the present invention;

FIG. 2 is a diagram for illustrating a method of supplying processing solutions to a development processing block and a cover film processing block;

FIG. 3 illustrates an exemplary hardware structure of a heating part;

FIG. 4 illustrates an exemplary structure of a cover film forming part; and

FIG. 5 is a diagram for illustrating a method of cleaning a cup part.

### DESCRIPTION OF THE PREFERRED EMBODIMENTS

An embodiment of the present invention is now described in detail with reference to the drawings.

<1. Structure of Substrate Processing System>

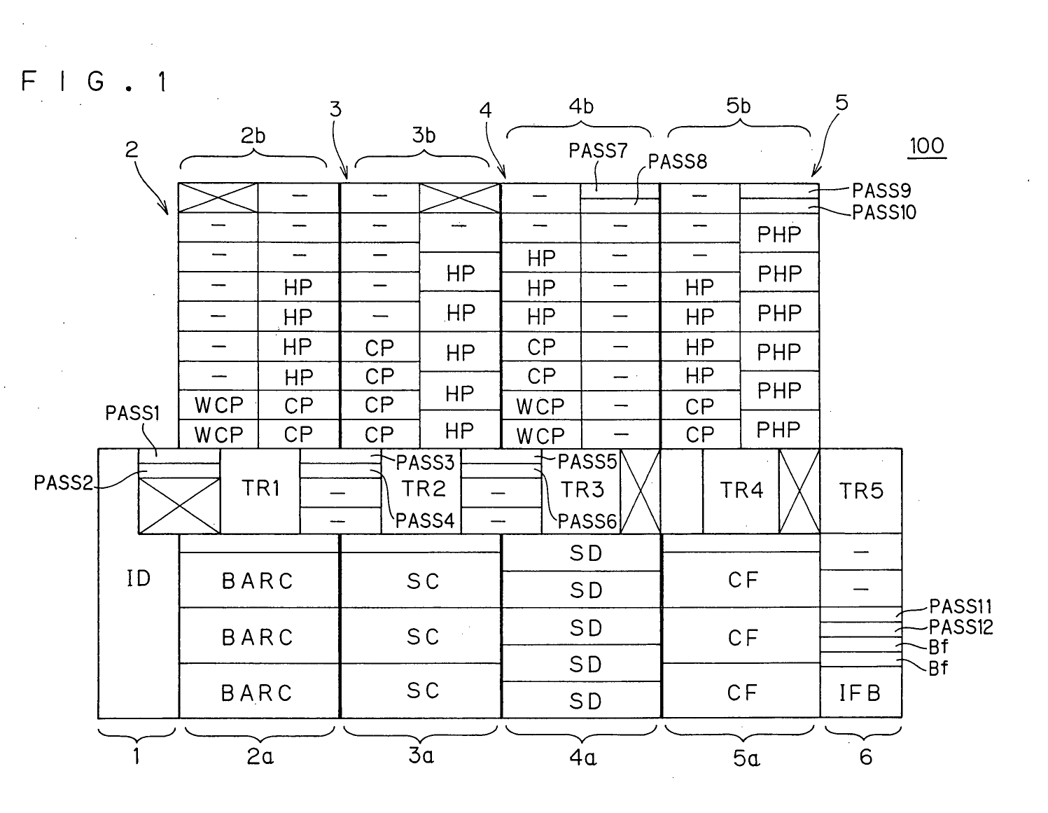

FIG. 1 illustrates an exemplary structure of a substrate processing system 100 according to the embodiment. The substrate processing system 100 forms antireflection film coatings, photoresist films and cover films on substrates in this order, and performs development processing on the substrates completely subjected to exposure processing.

As shown in FIG. 1, the substrate processing system 100 according to the embodiment is roughly formed by an indexer block 1, for processing blocks (more specifically, an antireflection coating processing block 2, a resist film processing block 3, a development processing block 4 and a cover film processing block 5) performing prescribed chemical solution processing on the substrates and an interface block 6, which are arranged in parallel with each other. An external exposure apparatus (stepper: not shown) independent of the substrate processing system 100 is provided in parallel with the interface block 6.

In the respective blocks 2 to 6, respective units of application processing parts 2a, 3a and 5a, a development processing part 4a and thermal processing parts 2b to 5b and a substrate receiving parts PASS1 to PASS12 are individually stacked and arranged despite the illustration in FIG. 1 for describing the apparatus structure. The units of the application processing parts 2a, 3a and 5a, the development processing part 4a and the thermal processing parts 2b to 5b are stacked and arranged upward from the sides closer to transfer mechanisms TR1 to TR5 respectively. In the following description, a term “processing solution” is used as a concept including deionized water and a chemical solution.

The indexer block 1 receives unprocessed substrates supplied from outside the substrate processing system 100 and discharges substrates completely subjected to prescribed processing in the substrate processing system 100.

The antireflection coating processing block 2 performs processing of forming the antireflection coatings for reducing standing waves and/or halation resulting from exposure. As shown in FIG. 1, the antireflection coating processing block 2 mainly comprises (1) the application processing part 2a having a plurality of application processing units BARC, (2) the thermal processing part 2b having a plurality of thermal processing units (hot plates HP and cooling plates CP and WCP) and (3) the transfer mechanism TR1 arranged on a position held between the application processing part 2a and the thermal processing part 2b for transferring and receiving the substrates to and from the respective units included in the application processing part 2a and the thermal processing part 2b as well as the respective ones of the substrate receiving parts PASS1 to PASS4.

The application processing units BARC can form the antireflection coatings on the surfaces of the substrates by supplying a chemical solution to the substrates while rotating/holding the same. Therefore, the application processing units BARC reduce standing waves and/or halation resulting from exposure for allowing excellent exposure processing.

The hot plates HP are units heating and maintaining the substrates to and at a prescribed temperature. The cooling plates WCP are used for roughly cooling the substrates, while the cooling plates CP are used for cooling the substrates while precisely controlling the temperature thereof.

The resist film processing block 3 performs processing of forming thin films of resist (chemically amplified resist in this embodiment) on the substrates formed with the antireflective coatings. As shown in FIG. 1, the resist film processing block 3 mainly comprises (1) the application processing part 3a having a plurality of application processing units SC, (2) the thermal processing part 3b having a plurality of thermal processing units (cooling plates CP and hot plates HP) and (3) the transfer mechanism TR2 arranged on a position held between the application processing part 3a and the thermal processing part 3b for transferring and receiving the substrates to and from the respective units included in the application processing part 3a and the thermal processing part 3b as well as the respective ones of the substrate receiving parts PASS3 to PASS6.

The application processing units SC can form the resist films on the antireflection coatings by supplying the chemical solution (resist) to the substrates while rotating/holding the same. The application processing units SC forming the resist films also executes edge rinsing and back rinsing for removing the resist partially adhering to the peripheral edges and back surfaces of the substrates.

The development processing block 4 performs development processing by supplying a developer to the substrates completely subjected to exposure processing. As shown in FIG. 1, the development processing block 4 mainly comprises (1) the development processing part 4a having a plurality of development processing units SD, (2) the thermal processing part 4b having a plurality of thermal processing units (hot plates HP and cooling plates CP and WCP) and (3) the transfer mechanism TR3 arranged on a position held between the development processing part 4a and the thermal processing part 4b for transferring and receiving the substrates to and from the respective units included in the development processing part 4a and the thermal processing part 4b as well as the respective ones of the substrate receiving parts PASS5 to PASS8.

The development processing units SD perform development processing with the developer, rinsing with deionized water and dry processing of draining the deionized water adhering to the substrates by rotating the substrates while holding the same.

According to this embodiment, the developer is prepared from an organic aqueous alkaline solution such as an aqueous tetramethylammonium hydroxide (TMAH) solution or an aqueous 2-hydroxyethylmethyl ammonium hydroxide (choline) solution. The resist films are prepared from positive resist converted to a chemical structure soluble in an alkaline solution by photochemical reaction of exposed portions. Further, a chemical solution such as the developer used in the development processing, which is dissolvable in an aqueous alkaline solution, is used as the component of the cover films.

In other words, unexposed resist films are insoluble in the developer, while exposed portions are soluble in the developer. On the other hand, the cover films are soluble in the developer.

The wording “insoluble in the developer” is considered as a concept also including a case of slight film loss of unexposed portions caused by the developer depending on the type of the resist in consideration of obvious difference from solubility of exposed portions.

Therefore, the developer supplied to the substrates formed with the resist films and the cover films removes exposed portions of the resist films and the cover films. In other words, no additional step is required for removing the cover films alone, whereby the number of processing steps of the overall substrate processing system 100 can be reduced for improving the throughput of processing.

The cover film processing block 5 performs processing of forming the cover films on the substrates formed with the antireflection coatings and the resist films and post-exposure baking processing of executing thermal processing on the completely exposed substrates at prescribed timing. As shown in FIG. 1, the cover film processing block 5 mainly comprises (1) the application processing part 5a having a plurality of application processing units CF, (2) the thermal processing part 5b having a plurality of thermal processing units (hot plates HP, cooling plates CP and heating parts PHP) and (3) the transfer mechanism TR4 arranged on a position held between the application processing part 5a and the thermal processing part 5b for transferring and receiving the substrates to and from the hot plates HP and the cooling plates CP of the thermal processing part 5b, the application processing units CF of the application processing part 5a and the respective ones of the substrate receiving parts PASS7 to PASS 10.

The exposure apparatus (not shown) used as an external device of the substrate processing system 100 performs exposure processing according to an immersion exposure technique. In other words, it follows that clearances between a projection optical system of the exposure apparatus and the substrates are filled with a liquid such as water. Thus, the component of the resist films may be eluted in this liquid to disadvantageously cause a problem such as nonuniform line widths of patterns formed on the resist films. According to this embodiment, the substrate processing system 100 performs processing of forming protective films (cover films) for protecting the resist films on the resist films, in order to solve this problem.

The application processing units CF can form the cover films on the antireflection coatings and the resist films by supplying a chemical solution to the substrates while rotating/holding the same. In other words, the application processing units CF can be used as apparatuses for forming the cover films.

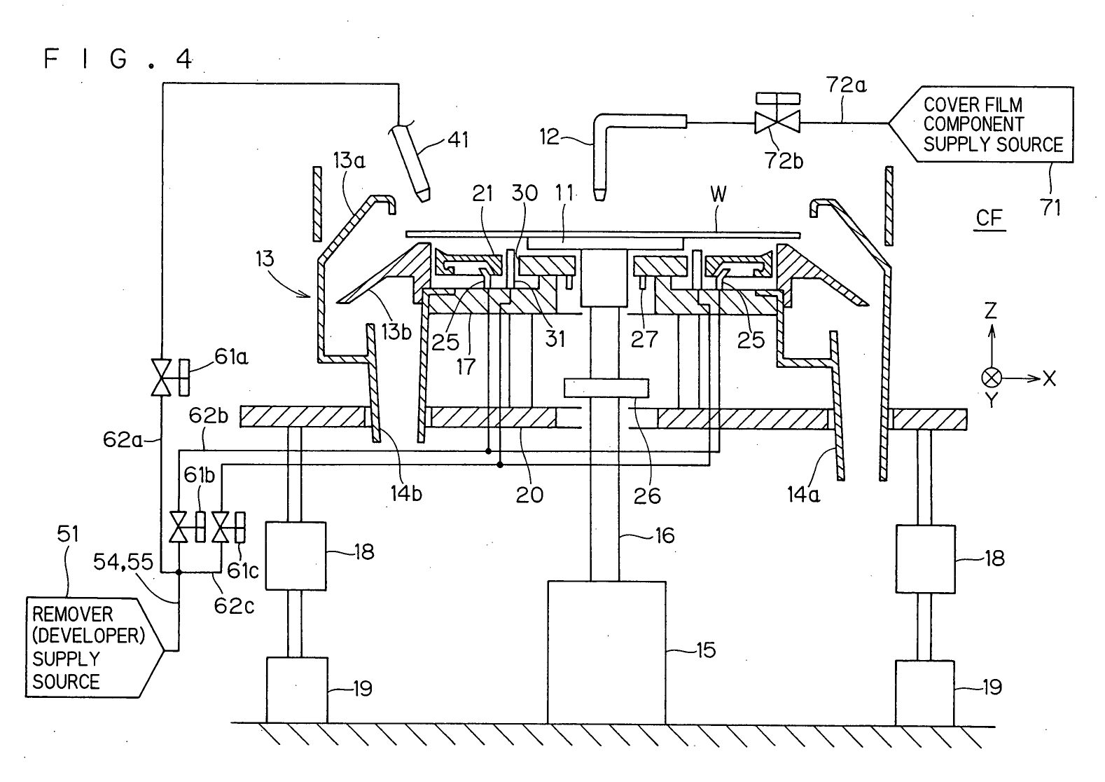

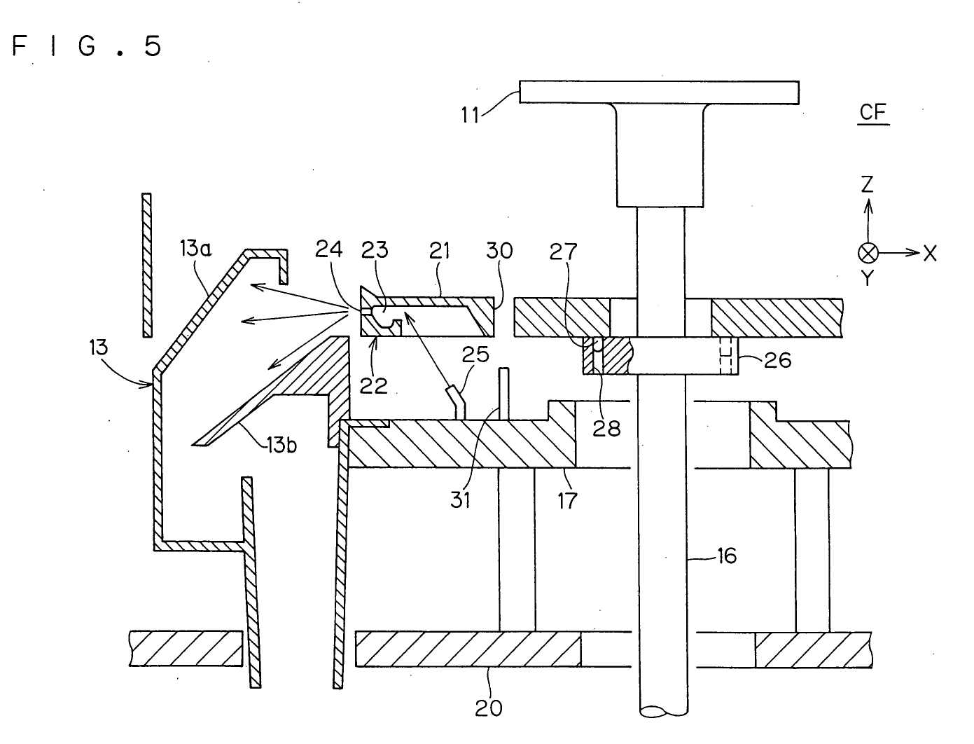

The application processing units CF also execute edge rinsing, back rinsing and cup rinsing of removing parts of the cover film component adhering to the peripheral edges and back surface portions of the substrates and a scattering prevention cup 13 (see FIGS. 4 and 5 described later). The details of the application processing units CF are described later.

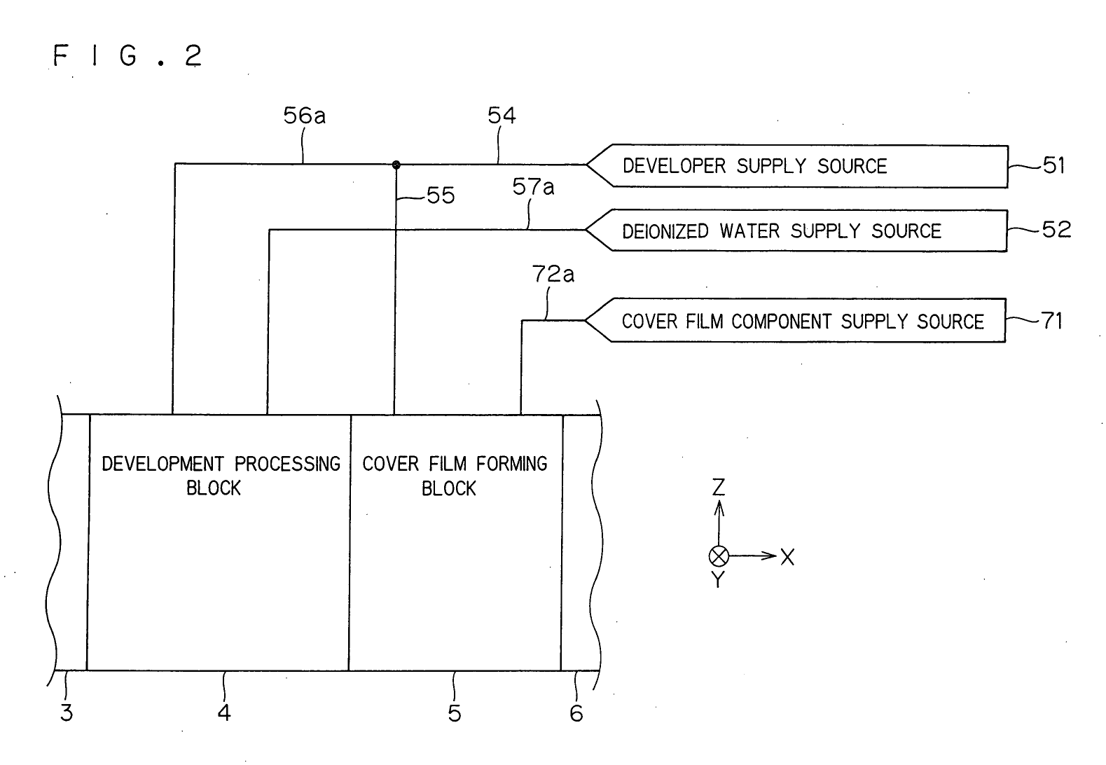

FIG. 2 is a diagram for illustrating a method of supplying the processing solutions to the development processing block 4 and the cover film processing block 5. A deionized water supply source 52 is communicatively connected with each development processing unit SD of the development processing block 4 through a pipe 57a, while a cover film component supply source 71 is communicatively connected with each application processing unit CF of the cover film processing block 5 through another pipe 72a.

As shown in FIG. 2, a developer supply source 51 is communicatively connected with (a) the development processing block 4 through a common pipe 54 and a branch pipe 56a and with (b) the cover film processing block 5 through the common pipe 54 and another branch pipe 55 respectively. The developer supply source 51 supplies the developer of the organic aqueous alkaline solution, which can remove not only the exposed portions of the resist films but also the cover films formed on the substrates as hereinabove described.

Thus, the developer supply source 51 can also serve as a cover film component remover supply source. Consequently, it is possible to remove the cover film component without separately providing a remover supply source and a remover supply line. Therefore, the footprint of the substrate processing system 100 can be reduced.

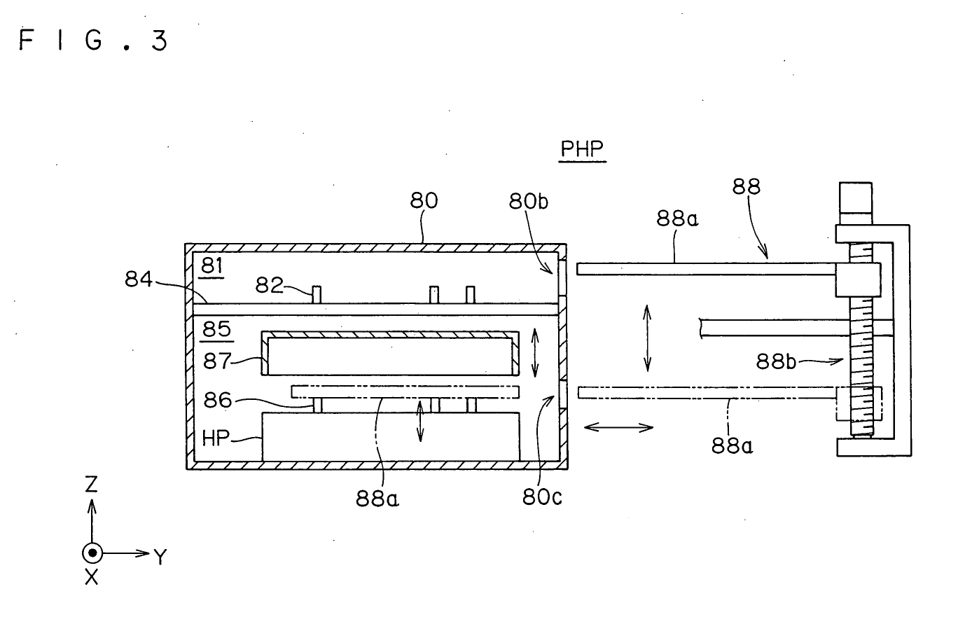

FIG. 3 illustrates an exemplary hardware structure of each heating part PHP. Each heating part PHP comprises a temporary substrate chamber 81 arranged in an upper portion of a housing 80, a heating chamber 85 arranged in a lower portion of the housing 80 with the hot plate HP and a local transfer mechanism 88. A partition member 84 partitions the internal space of the housing 80 into the temporary substrate chamber 81 and the heating chamber 85. Therefore, the temporary substrate chamber 81 can temporarily store the substrates with no thermal influence from the heating chamber 85.

In the temporary substrate chamber 81, fixed support pins 82 support the exposed substrates transferred from the transfer mechanism TR5 (included in the interface block 6) described later to the heating part PHP.

A holding plate 88a of the local transfer mechanism 88 is vertically movable by a screw feeding/driving mechanism 88b. The local transfer mechanism 88 is rendered horizontally reciprocative. Thus, the holding plate 88a is vertically movable and enterable into the temporary substrate chamber 81 and the heating chamber 85 through openings 80b and 80c respectively. Therefore, the holding plate 88a can transfer the substrates between the temporary substrate chamber 81 and the heating chamber 85. The holding plate 88a may additionally have a cooling function for transferring the substrates while cooling the same.

A plurality of movable support pins 86 are retractively provided on the surface of each hot plate HP of the heating chamber 85. A vertically movable top cover 87 is provided above the hot plate HP, for covering the substrates in thermal processing.

Thus, each heating part PHP can perform post-exposure baking processing of performing thermal processing at prescribed timing while temporarily storing the substrates in the temporary substrate chamber 81. Also when employing the chemically amplified resist requiring precise control of the time between completion of exposure processing and start of thermal processing, therefore, it is possible to precisely control dimensional accuracy of the line widths of the patterns formed on the resist films etc.

The interface block 6 transfers and receives the substrates to and from the exposure apparatus (not shown) used as the external device of the substrate processing system 100. This interface block 6 mainly comprises (1) an interface IFB transferring and receiving the substrates to and from the exposure apparatus, (2) a plurality of buffers Bf temporarily storing unexposed substrates and completely exposed substrates and (3) the transfer mechanism TR5 transferring and receiving the substrates to and from the substrate receiving parts PASS9 to PASS12 and the respective ones of the heating parts PHP of the cover film processing block 5.

The interface IFB introduces the substrates completely formed with the antireflection coatings, the resist films and the cover films and placed on the substrate receiving part PASS11 into the exposure apparatus. The interface IFB further places the completely exposed substrates on the substrate receiving part PASS12. When the exposure apparatus cannot accept the substrates, the interface IFB transfers the unexposed substrates to the buffers Bf.

While an interfacial transfer mechanism (not shown) of the interface IFB performs the processing of transferring the unexposed substrates to the buffers Bf, the transfer mechanism TR5 executes the processing of transferring the exposed substrates completely subjected to thermal processing in the heating part PHP to the buffers Bf due to the hardware structure.

<2. Structure of Application Processing Unit CF>

FIG. 4 illustrates an exemplary hardware structure of each application processing unit CF. FIG. 5 is a diagram for illustrating a method of cleaning a cup part. The hardware structure of the application processing unit CF is described with reference to FIGS. 4 and 5, along with description of edge rinsing, back rinsing and cup rinsing performed by this unit CF.

The respective ones of the plurality of application processing units CF included in the application processing part 5a are similar in hardware structure to each other. Therefore, the following description is made as to only one of the plurality of application processing units CF.

The application processing unit CF is a unit forming the cover films to cover the antireflection coatings and the resist films formed on the substrates. As shown in FIG. 4, the application processing unit CF mainly comprises a spin chuck 11 rotating each circular substrate W while holding the same, a processing solution supply nozzle 12 supplying the cover film component to the substrate W, the scattering prevention cup 13 receiving the cover film component scattered from the substrate W, an edge cleaning nozzle 41 supplying the remover (developer) to the peripheral edge of the substrate W, back surface cleaning nozzles 31 supplying the remover to the back surface of the substrate W and a cup cleaning member 21 supplying the remover to the scattering prevention cup 13.

The processing solution supply nozzle 12 is arranged above the spin chuck 11 and communicatively connected with the cover film component supply source 71 through a pipe 72a and a valve 72b, as shown in FIG. 4. Therefore, the application processing unit CF can supply the cover film component to the upper surface of the substrate W by switch-controlling the valve 72b at prescribed timing.

The spin chuck 11 is a holding part adsorptively holding the substrate W. This spin chuck 11 is communicatively connected with a drive motor 15 through a rotary shaft 16. When the processing solution supply nozzle 12 supplies the chemical solution of the cover film component toward a substantially central position of the surface of the substrate W while the spin chuck 11 rotates/holds the substrate W, the supplied chemical solution centrifugally spreads over the surface of the substrate W so that a uniform cover film can be formed. Part of the chemical solution centrifugally reaching the peripheral edge of the substrate W extends toward the back surface of the substrate W. The scattering prevention cup 13 receives another part of the chemical solution scattered from the substrate W.

The scattering prevention cup 13 is arranged to enclose the substrate W held by the spin chuck 11 in formation of the cover film (see FIG. 4), for receiving the cover film component scattered from the substrate W. As shown in FIG. 4, the scattering prevention cup 13 is mainly double-cylindrically constituted of an outer cup 13a and a rectifying member 13b arranged on the bottom of the outer cup 13a to face the back surface of the substrate W, and held by a base plate 17.

The base plate 17 itself is mounted on a vertically movable plate 20 supported by a vertical pair of cylinders 18 and 19. Thus, the scattering prevention cup 13 is vertically movable in three stages through telescopic combination of the cylinders 18 and 19.

A waste recovery drain 14a for recovering and discharging an excessive part of the processing solution and an exhaust port 14b for exhausting the scattering prevention cup 13 are provided under the scattering prevention cup 13. The recovered waste is transmitted to a neutralization chamber (not shown) in a semiconductor factory, to be processed. On the other hand, exhaust air discharged from the exhaust port 14b is discharged to an exhaust duct (not shown).

When the transfer mechanism TR4 receives any substrate W in such a state that the chemical solution of the cover film component adheres to the peripheral edge of the surface and/or the back surface portion thereof, the cover film component adheres to the transfer mechanism TR4 to cause particles. Therefore, the application processing unit CF can execute edge rising for removing the cover film component adhering to the peripheral edge of the substrate W and back rinsing for removing the cover film component extending and adhering to the back surface portion of the substrate W in parallel with the processing of forming the cover film.

The edge cleaning nozzle 41 is a nozzle provided above the peripheral edge of the substrate W for supplying the remover to this peripheral edge. As shown in FIGS. 2 and 4, the edge cleaning nozzle 41 is communicatively connected with the remover (developer) supply source 51 through an edge-side pipe 62a, a valve 61a, the branch pipe 55 and the common pipe 54. Therefore, the edge cleaning nozzle 41 can remove the cover film component adhering to the peripheral edge of the substrate W by switch-controlling the valve 61a while rotating/holding the substrate W. In other words, the spin chuck 11 and the edge cleaning nozzle 41 supplying the developer used as the remover for the cover film are employed as removing apparatuses for the cover film component.

As shown in FIG. 4, the plurality of back surface cleaning nozzles 31 are arranged on the upper surface of the base plate 17 for spraying and supplying the remover to the back surface portion of the substrate W. As shown in FIGS. 2 and 4, each back surface cleaning nozzle 31 is communicatively connected with the remover (developer) supply source 51 through a cup-side pipe 62c, a valve 61c, the branch pipe 55 and the common pipe 54.

The cup cleaning member 21 arranged above the base plate 17 is provided with a through hole 30 corresponding to each back surface cleaning nozzle 31. When both cylinders 18 and 19 are expanded for moving up the scattering prevention cup 13 to a vertical position substantially flush with the spin chuck 11, therefore, each back surface cleaning nozzle 31 is inserted into the corresponding through hole 30 (see FIG. 4).

When the back surface cleaning nozzle 31 supplies the remover to the back surface of the substrate W by switch-controlling the valve 61c while the spin chuck 11 rotates/holds the substrate W, therefore, the remover centrifugally reaches the peripheral edge of the back surface of the substrate W. Thus, the cover film component extending from the surface of the substrate W and adhering to the back surface can be removed. In other words, the spin chuck 11 and the back surface cleaning nozzle 31 supplying the developer used as the remover for the cover film are employed as removing apparatuses for the cover film component adhering to the back surface of the substrate W.

Thus, the application processing unit CF performs edge rinsing and back rinsing on the unexposed substrate W by supplying the developer of the aqueous alkaline solution as the remover.

Therefore, the application processing unit CF can remove only the cover film component adhering to the peripheral edge and the back surface portion of the substrate W without influencing the resist film prepared from the positive resist. In other words, the application processing unit CF can selectively remove only the cover film without removing the resist film.

Cup rinsing for removing the cover film component adhering to the scattering prevention cup 13 is now described. As hereinabove described, part of the cover film component scattered fro the substrate W is received by the scattering prevention cup 13 and adheres to the same.

If left in the state adhering to the scattering prevention cup 13, the cover film component causes particles resulting in defective substrate processing. Therefore, the application processing unit CF is formed to be capable of executing cup rinsing when not executing the processing of forming the cover film.

The cup cleaning member 21 is a member supplying the remover (developer) into the scattering prevention cup 13. As shown in FIGS. 4 and 5, the cup cleaning member 21 having a substantially discoidal shape with a larger diameter than the spin chuck 11 is arranged between the spin chuck 11 and the base plate 17 and fitted with the rotary shaft 16.

In cup rinsing, both cylinders 18 and 19 are contracted to move down the scattering prevention cup 13 to a vertical position substantially flush with the cup cleaning member 21, as shown in FIG. 5. Thus, a pin 27 formed on a central side of the lower surface of the cup cleaning member 21 engages with an engaging hole 28 of a rotation transmission part 26 to be interlocked/connected with the drive motor 15 through the rotary shaft 16. When the drive motor 15 is driven in cup rinsing, therefore, it follows that the cup cleaning member 21 integrally rotates with the rotary shaft 16.

The remover supply nozzle 25 is communicatively connected with the remover (developer) supply source 51 through a back-side pipe 62b, a valve 61b, the branch pipe 55 and the common pipe 54, as shown in FIGS. 2 an 4. Thus, the remover supply nozzle 25 can supply the remover to a recess 23 of a remover guide part 22 formed in the cup cleaning member 21.

When the remover supply nozzle 25 supplies the remover while rotating the cup cleaning member 21 in cup rinsing (see FIG. 5), therefore, the remover reaches the recess 23 of the remover guide part 22 and centrifugally spouts out from a remover outlet 24. Thus, the cup cleaning member 21 can supply the remover to the scattering prevention cup 13 for executing cup rinsing for removing the cover film component adhering to the inner part of the scattering prevention cup 13. In other words, the spin chuck 11, the remover supply nozzle 25 supplying the developer used as the remover for the cover film and the cup cleaning member 21 are employed as removing apparatuses for the cover film component adhering to the back surface of the substrate W.

As hereinabove described, the substrate processing system 100 uses not an organic solvent but the organic aqueous alkaline solution as the remover in edge rinsing, back rinsing and cup rinsing. Therefore, the neutralization chamber set in the semiconductor factory as common equipment can process the waste for reducing the cost for waste processing.

Further, the substrate processing system 100 can remove the cover film component without using an organic solvent, whereby the quantity of a used organic solvent as well as the quantity of organic waste can be reduced.

<3. Operation of Substrate Processing System>

Substrate processing operations in the indexer block 1, the antireflection coating processing block 2, the resist film processing block 3, the development processing block 4, the cover film processing block 5 and the interface block 6 included in the substrate processing system 100 are now described.

The indexer block 1 receives a cassette (not shown) storing a plurality of unprocessed substrates from outside the substrate processing system 100. The indexer block 1 places the unprocessed substrates extracted from the cassette on the substrate receiving part PASS1.

When the substrates subjected to prescribed processing in the respective blocks 2 to 6 are placed on the substrate receiving part PASS2, the indexer block 1 stores the processed substrates in a corresponding cassette.

The antireflection coating processing block 2 performs processing of forming the antireflection coatings on the surfaces of the substrates and necessary thermal processing on the unprocessed substrates placed on the substrate receiving part PASS1 with the application processing units BARC, the hot plates HP and the cooling plates CP and WCP. The antireflection coating processing block 2 places the completely processed substrates on the substrate receiving part PASS3.

When the substrates completely subjected to prescribed processing in the blocks 3 to 6 are placed on the substrate receiving part PASS4, the transfer mechanism TR1 of the antireflection coating processing block 2 transfers and places the substrates placed on the substrate receiving part PASS4 to and on the substrate receiving part PASS2.

The resist film processing block 3 performs prosing of forming the resist films on the surfaces of the substrates and necessary thermal processing on the substrates formed with the antireflection coatings and placed on the substrate receiving part PASS3. The resist film processing block 3 places the completely processed substrates on the substrate receiving part PASS5.

When the substrates completely subjected to prescribed processing in the blocks 4 to 6 are placed on the substrate receiving part PASS6, the transfer mechanism TR2 of the resist film processing block 3 transfers and places the substrates placed on the substrate receiving part PASS6 to and on the substrate receiving part PASS4.

The development processing block 4 performs development processing and necessary thermal processing on the substrates completely subjected to prescribed processing in the blocks 5 and 6 and placed on the substrate receiving part PASS8 with the development processing units SD, the hot plates HP and the cooling plates CP and WCP. The development processing block 4 places the completely processed substrates on the substrate receiving part PASS6.

When the substrates formed with the antireflection coatings and the resist films are placed on the substrate receiving part PASS5, the transfer mechanism TR3 of the development processing block 4 transfers and places the substrates placed on the substrate receiving part PASS5 to and on the substrate receiving part PASS7.

The cover film processing block 5 performs processing of forming the cover films. The cover film processing block 5 also performs post-exposure baking processing in association with the transfer mechanism TR5 of the interface block 6. The cover film processing block 5 and the interface block 6 execute necessary transfer processing.

More specifically, the application processing units CF, the hot plates HP and the cooling plates CP perform the processing of forming the cover films and necessary thermal processing on the substrates formed with the antireflection coatings and the resist films and placed on the substrate receiving part PASS7. The substrates formed with the cover films are placed on the substrate receiving part PASS9. Then, the transfer mechanism TR5 of the interface block 6 transfers and places the substrates placed on the substrate receiving part PASS9 to and on the substrate receiving part PASS11. The interfacial transfer mechanism (not shown) of the interface block 6 transfers the substrates placed on the substrate receiving part PASS1 to the exposure apparatus (not shown) at the prescribed timing.

When the interfacial transfer mechanism (not shown) places the substrates completely exposed in the exposure apparatus (not shown) on the substrate receiving part PASS12, the transfer mechanism TR5 transfers the substrates placed on the substrate receiving part PASS12 to the heating parts PHP. The heating parts PHP perform post-exposure baking processing for performing thermal processing at prescribed timing. The transfer mechanism TR5 places the substrates completely subjected to post-exposure baking processing on the substrate receiving part PASS10.

As hereinabove described, the substrate processing system 100 according to this embodiment successively transfers the substrates to be processed through the substrate receiving parts PASS1, PASS3, PASS5, PASS7, PASS9, PASS11, PASS12, PASS10, PASS8, PASS6, PASS4 and PASS2. Thus, it follows that the substrates are formed with the antireflection coatings, the resist films and the cover films and subjected to post-exposure baking processing and development processing in this order.

<4. Advantage of Substrate Processing System according to this Embodiment>

As hereinabove described, the application processing units CF according to this embodiment can supply the developer of the aqueous alkaline solution used for development processing to the peripheral edges of the substrates as the remover. Therefore, the substrate processing system 100 can selectively and easily remove the cover films formed on the peripheral edges of the substrates without influencing the positive resist films formed as preprocessing for cover film formation in edge rising.

When selecting a substance insoluble in this remover as the component of the antireflection coatings, it is possible to execute edge rinsing without influencing the resist films and the antireflection coatings.

The application processing units CF according to this embodiment use not an organic solvent but the aqueous alkaline solution as the remover. Therefore, it is possible to reduce the quantity of a used organic solvent as well as the quantity of organic waste in edge rinsing, back rinsing and cup rinsing.

Further, the neutralization chamber set in the semiconductor factory as common equipment can process the waste resulting from cover film removal processing in this embodiment. Therefore, it is possible to reduce the cost required for processing the waste.

In addition, the substrate processing system 100 according to this embodiment can use the developer as the remover for the cover films. Therefore, the substrate processing system 100 may not be separately provided with a supply line dedicated to supply of the remover.

When supplying the developer to the substrates in development processing performed in the development processing units SD, the substrate processing system 100 can remove not only exposed portions of the resist films but also the cover films. Therefore, no step may be separately provided for removing the cover films after exposure processing but the throughput of substrate processing can be improved.

<5. Modification>

While the embodiment of the present invention has been described, the present invention is not restricted to the aforementioned example.

(1) While the substrate processing system 100 uses the organic aqueous alkaline solution as the remover in this embodiment, the present invention is not restricted to this. The remover may alternatively be prepared from an inorganic aqueous alkaline solution such as potassium hydroxide (KOH), sodium hydroxide (NaOH) or sodium carbonate (Na₂CO₃), for example.

(2) While the substrate processing system 100 according to this embodiment executes edge rinsing and back rinsing on circular substrates, the processed substrates are not restricted to circular ones but angular substrates such as substrates for liquid crystal displays may alternatively be processed, for example.

While the invention has been shown and described in detail, the foregoing description is in all aspects illustrative and not restrictive. It is therefore understood that numerous modifications and variations can be devised without departing from the scope of the invention.

What is claimed is:

1. A removing apparatus for removing a protective film formed to cover a resist film on the surface of a substrate, comprising:
a holding part holding said substrate; and
a first supply part supplying an aqueous alkaline solution to the peripheral edge of unexposed said substrate as a remover, wherein
said protective film is soluble in said remover, and
said resist film is insoluble in said remover except a portion subjected to exposure processing.

2. The removing apparatus according to claim 1, further comprising a second supply part supplying said aqueous alkaline solution to a protective film component adhering to a back surface portion of said substrate as said remover.

3. The removing apparatus according to claim 2, further comprising:
a cup part enclosing said substrate held by said holding part, and
a third supply part supplying said aqueous alkaline solution to a protective film component adhering to said cup part as said remover.

4. A removing apparatus for removing a protective film component adhering to a back surface portion of a substrate, comprising:
a holding part holding said substrate; and
a supply part supplying an aqueous alkaline solution to said back surface portion of unexposed said substrate as a remover, wherein
said protective film is formed to cover a resist film formed on the surface of said substrate and soluble in said remover, and
said resist film is insoluble in said remover except a portion subjected to exposure processing.

5. A removing apparatus comprising:
a holding part holding a substrate while rotating the same;
a cup part enclosing said substrate held by said holding part; and
a supply part supplying an aqueous alkaline solution to said cup part to which a protective film component adheres as a remover, wherein
a protective film is formed to cover a resist film on the surface of said substrate and soluble in said remover, and
said resist film is insoluble in said remover except a portion subjected to exposure processing.

6. The removing apparatus according to claim 1, wherein
said remover is tetramethylammonium hydroxide.

7. The removing apparatus according to claim 4, wherein
said remover is tetramethylammonium hydroxide.

8. The removing apparatus according to claim 5, wherein
said remover is tetramethylammonium hydroxide.

9. A protective film forming apparatus for forming a protective film by applying a protective film component to a substrate formed with a resist film, comprising:
a holding part holding said substrate;
a protective film component supply part supplying said protective film component to said substrate held by said holding part; and
a first remover supply part supplying an aqueous alkaline solution to the peripheral edge of said substrate as a remover, wherein
said protective film is formed to cover said resist film formed on the surface of said substrate and soluble in said remover, and
said resist film is insoluble in said remover except a portion subjected to exposure processing.

10. The protective film forming apparatus according to claim 9, further comprising a second supply part supplying said aqueous alkaline solution to a back surface portion of said substrate as said remover.

11. The protective film forming apparatus according to claim 10, further comprising:
a cup part enclosing said substrate held by said holding part, and
a third supply part supplying said aqueous alkaline solution to said cup part to which said protective film component adheres as said remover, wherein
said holding part is rotatable while holding said substrate.

12. The protective film forming apparatus according to claim 9, wherein
said remover is tetramethylammonium hydroxide.

13. A substrate processing system comprising:
the protective film forming apparatus according to claim 9;
a resist applicator applying resist to the surface of said substrate;
a thermal processor performing thermal processing on said substrate; and
a transferrer transferring said substrate to each device.

14. The substrate processing system according to claim 13, further comprising a developing apparatus having:
a developer supply part supplying a developer to completely exposed said substrate, and
a holding part holding said substrate, wherein
said protective film forming apparatus uses said developer supplied from said developer supply part in a branched manner as said remover.

15. A removing method for removing a protective film formed to cover a resist film on the surface of a substrate, comprising steps of:
(a) holding said substrate on a holding part; and
(b) supplying an aqueous alkaline solution to the peripheral edge of unexposed said substrate as a remover, wherein
said protective film is soluble in said remover, and
said resist film is insoluble in said remover except a portion subjected to exposure processing.

16. A removing method for removing a protective film component adhering to a back surface portion of a substrate, comprising steps of:
(a) holding said substrate on a holding part; and
(b) supplying an aqueous alkaline solution to said back surface portion of unexposed said substrate as a remover, wherein
said protective film is formed to cover a resist film formed on the surface of said substrate and soluble in said remover, and
said resist film is insoluble in said remover except a portion subjected to exposure processing.

17. A removing method comprising steps of:
(a) performing chemical solution processing on a substrate; and
(b) supplying an aqueous alkaline solution to a cup part to which a protective film component adheres through said step (a) as a remover, wherein
said cup part encloses said substrate held by said holding part,
said protective film is formed to cover a resist film on the surface of said substrate and soluble in said remover, and
said resist film is insoluble in said remover except a portion subjected to exposure processing.
